(19) United States
(12) Patent Application Publication
(10) Pub. No.: US 2014/0191447 A1
(43) Pub. Date: Jul. 10, 2014

(54) SYSTEM FOR MANUFACTURING COMPOSITE MATERIAL BY VACUUMING AND RESIN INJECTION AND THE METHOD FOR MANUFACTURING THE SAME

(71) Applicant: Mei-Chen Chiu, Taipei (TW)

(72) Inventor: Mei-Chen Chiu, Taipei (TW)

(21) Appl. No.: 13/736,965

(22) Filed: Jan. 9, 2013

(51) Int. Cl. B29C 45/00

(52) U.S. Cl. CPC B29C 45/0005
USPC 264/571; 425/585

(57) ABSTRACT

A method for manufacturing composite material by vacuuming and resin injection includes the steps of starting with placing and sealing a fiber substance into a mold. The mold is pumped by a vacuum pumping device, and a pressure tank containing resin is pumped by a vacuum pumping device. After the pressure tank and the mold reaching predetermined vacuum conditions, a valve between the vacuum pumping device and the mold and a valve between the vacuum pumping device and the pressure tank are closed. A valve between the pressure tank and the mold is thus opened. Resin inside the pressurized pressure tank is pushing into the mold. After the mold reaching a predetermined pressure, a heater is turned on to heat the resin and fiber for thermosetting process. The heater is turned off after a predetermined reaction condition being reached, and a cooler is thus turned on to cool the mold.

### FIELD OF THE INVENTION

The present invention relates to manufacture of composite material, and particular to a system for manufacturing composite material by vacuuming and resin injection and the method for manufacturing the same.

### DESCRIPTION OF THE PRIOR ART

There are known methods for manufacturing composite material.

A pre-impregnated cloth molding method is a process using an upper and lower mold set to shape a fiber which is soaked in resin in advance. Such method is fast but gas is easily remained in the work piece.

An autoclave molding is a process placing a pre-impregnated cloth wrapped by a vacuum bag into an autoclave. During the molding process, the bag inside a mold is pumped and the autoclave will provide an environment of high pressure and high temperature in the same time. Such method can effectively remove gas from the work piece, but the process is time consuming and requiring more cost for equipment.

A resin transfer molding method is a process placing a fiber substance wrapped by a bag into the cavity of a mold. The bag is pumped and resin is introduced into the bag through vacuum infusion. Such method is cheaper than the autoclave molding but the process time is long and the distribution of resin of the work piece is not uniform.

### SUMMARY OF THE PRESENT INVENTION

Accordingly, the primary object of the present invention is to provide a system for manufacturing composite material by vacuuming and resin injection and the method for manufacturing the same which has shorter process time and low equipment cost.

To achieve above object, the present invention provides a system for manufacturing composite material by vacuuming and resin injection, comprising: a mold having a seal portion; a left connector and a right connector connected to two lateral sides of the mold respectively; a first vacuum pumping device being connected to the right connector through a vacuum piping having a first valve; a vacuum gauge being connected to the piping between the first valve and the right connector; a fiber being placed into the cavity of the mold; a heater and cooler being arranged in the mold; a pressure tank containing resin therein being connected by a top piping and a bottom piping on an upper side and a lower side thereof, respectively; the bottom piping being connected to the left connector through a fourth valve so that the resin inside the pressure tank can be pushed into the mold through the bottom piping; the top piping having two branches connected to a second vacuum pumping device and a pressure source respectively; the second vacuum pumping device being isolated from the pressure tank by a second valve; and the pressure source being isolated from the pressure tank by a third valve.

A method for manufacturing composite material by vacuuming and resin injection; the method is used in a system of claim 1, the method comprising the steps of: placing carbon fiber into the cavity of the mold; the cavity of the mold being enclosed by the seal portion; opening the second valve; and activating the vacuum pumping device so that air in the pressure tank with resin therein is pumped; opening the first valve and activating the vacuum pumping device connected to the mold so that the mold is pumped; after the pressure tank and the mold reaching predetermined vacuum conditions, closing the first valve and the second valve to isolate the vacuum pumping devices from the pressure tank and the mold respectively; then opening the fourth valve between the pressure tank and the mold; at this moment, the pressure tank and the mold being vacuumed; and air in the resin within the pressure tank being completely pumped out of the pressure tank; opening the valve opened so that the pressure source pressurizes the pressure tank and push the resin inside the pressure tank to the fiber in the cavity of the mold through the piping, the valve, and the left connector; closing the valve and after the mold reaching a predetermined pressure measured by the pressure gauge so as to stop the infilling of resin into the mold; turning on the heater to heat the resin and fiber in the cavity of the mold for thermosetting process; turning off the heater after a predetermined reaction condition reached; turning on the cooler to cool the mold and opening the seal portion to remove the work piece after cooling process.

The various objects and advantages of the present invention will be more readily understood from the following detailed description when read in conjunction with the appended drawing.

### BRIEF DESCRIPTION OF THE DRAWINGS

FIG. 1 is a schematic view showing the equipment for manufacturing composite material according to the present invention.

FIG. 2 is a schematic view showing a filler is placed into the mold cavity.

FIG. 3 is a flow chart of the manufacture method of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

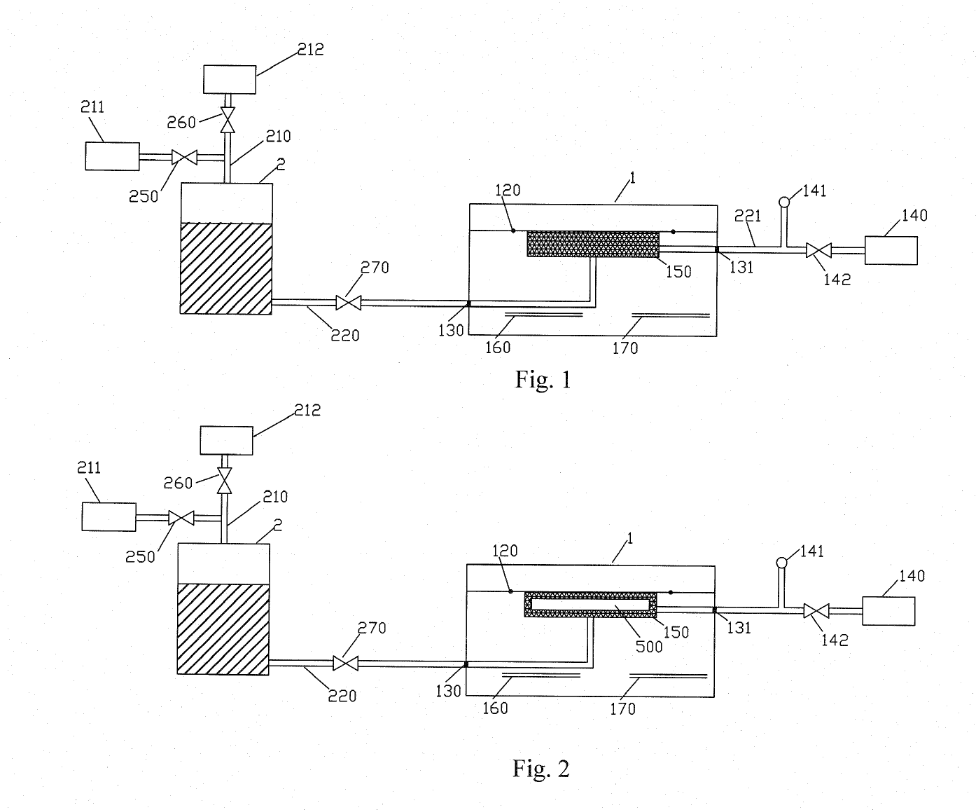

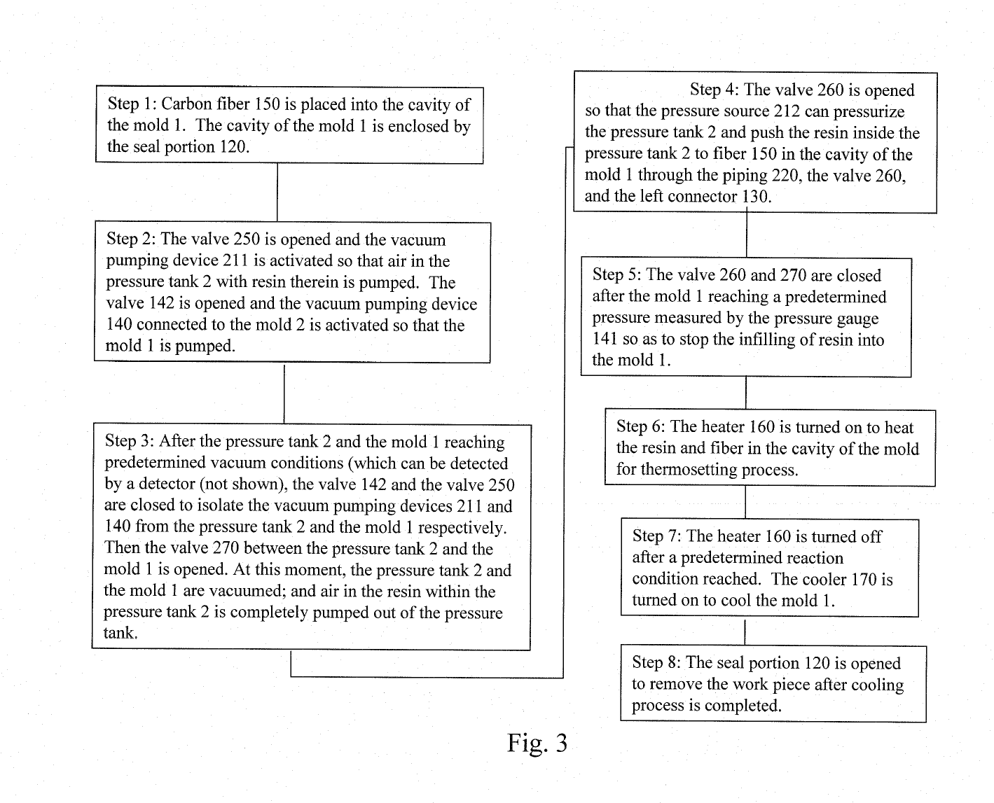

Referring to FIG. 1, a manufacture of composite material and its equipment according to the present invention includes the following elements.

A mold 1 has a seal portion 120 and a left connector 130 and a right connector 131 connected to two lateral sides of the mold 1 respectively. A vacuum pumping device 140 is connected to the right connector 131 through a vacuum piping 221 having a valve 142. A vacuum gauge 141 is connected to the piping 221 between the valve 142 and the right connector 131. A fiber 150 such as carbon fiber or glass fiber is placed into the cavity of the mold 1. A heater 160 and cooler 170 are arranged to the mold 1.

A pressure tank 2 containing resin therein is connected by a top piping 210 and a bottom piping 220 on an upper side and a lower side thereof, respectively. The bottom piping 220 is connected to the left connector 130 through a fourth valve 270 so that the resin inside the pressure tank 2 can be pushed into the mold 1 through the bottom piping 220. The top piping 210 has two branches connected to a vacuum pumping device 211 and a pressure source 212 respectively. The vacuum pumping device 211 is isolated from the pressure tank 2 by a valve 250, and the pressure source 212 is isolated from the pressure tank 2 by a valve 260.

The fiber in the cavity of the mold 1 can contain a filler 500 for the purpose to reduce the weight of the work piece through a structure of “sandwich panel”.

A method of the injection molding according to the present invention includes the following steps.

Step 1: Carbon fiber 150 is placed into the cavity of the mold 1. The cavity of the mold 1 is enclosed by the seal portion 120.

Step 2: The valve 250 is opened and the vacuum pumping device 211 is activated so that air in the pressure tank 2 with resin therein is pumped. The valve 142 is opened and the vacuum pumping device 140 connected to the mold 2 is activated so that the mold 1 is pumped.

Step 3: After the pressure tank 2 and the mold 1 reaching predetermined vacuum conditions (which can be detected by a detector (not shown), the valve 142 and the valve 250 are closed to isolate the vacuum pumping devices 211 and 140 from the pressure tank 2 and the mold 1 respectively. Then the valve 270 between the pressure tank 2 and the mold 1 is opened. At this moment, the pressure tank 2 and the mold 1 are vacuumed; and air in the resin within the pressure tank 2 is completely pumped out of the pressure tank.

Step 4: The valve 260 is opened so that the pressure source 212 can pressurize the pressure tank 2 and push the resin inside the pressure tank 2 to fiber 150 in the cavity of the mold 1 through the piping 220, the valve 260, and the left connector 130.

Step 5: The valve 260 and 270 are closed after the mold 1 reaching a predetermined pressure measured by the pressure gauge 141 so as to stop the infilling of resin into the mold 1.

Step 6: The heater 160 is turned on to heat the resin and fiber in the cavity of the mold for thermosetting process.

Step 7: The heater 160 is turned off after a predetermined reaction condition reached. The cooler 170 is turned on to cool the mold 1.

Step 8: The seal portion 120 is opened to remove the work piece after cooling process is completed.

Referring to FIG. 2, a filler 500 is added to the fiber 150 and then they are placed into the cavity of the mold 1 to form as a sandwich panel. The filler 500 is used to lower the weight of the finished work piece.

Through above components and process, residues of gas, solvent, and volatile substance within the fiber and resin can be effectively removed by vacuum pumping devices. The pressurized resin can be effectively soaked by the fiber. Through the heater and cooler, a work piece of high density and rigidity can be formed quickly with rare gas cavity remained inside the work piece.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A system for manufacturing composite material by vacuuming and resin injection, comprising:
a mold having a seal portion; a left connector and a right connector connected to two lateral sides of the mold respectively; a first vacuum pumping device being connected to the right connector through a vacuum piping having a first valve; a vacuum gauge being connected to the piping between the first valve and the right connector; a fiber being placed into the cavity of the mold; a heater and cooler being arranged in the mold;
a pressure tank containing resin therein being connected by a top piping and a bottom piping on an upper side and a lower side thereof, respectively; the bottom piping being connected to the left connector through a fourth valve so that the resin inside the pressure tank can be pushed into the mold through the bottom piping; the top piping having two branches connected to a second vacuum pumping device and a pressure source respectively; the second vacuum pumping device being isolated from the pressure tank by a second valve; and the pressure source being isolated from the pressure tank by a third valve.

2. The system of claim 1, wherein the fiber in the cavity of the mold contains a filler for reducing the weight thereof.

3. The system of claim 1, wherein the fiber is one of a carbon fiber and a glass fiber.

4. The system of claim 1, wherein the composite material is suitable as material for car body and for electronic products.

5. A method for manufacturing composite material by vacuuming and resin injection; the method is used in a system of claim 1, the method comprising the steps of:
placing carbon fiber into the cavity of the mold; the cavity of the mold being enclosed by the seal portion;
opening the second valve; and activating the vacuum pumping device so that air in the pressure tank with resin therein is pumped;
opening the first valve and activating the vacuum pumping device connected to the mold so that the mold is pumped;
after the pressure tank and the mold reaching predetermined vacuum conditions, closing the first valve and the second valve to isolate the vacuum pumping devices from the pressure tank and the mold respectively;
then opening the fourth valve between the pressure tank and the mold; at this moment, the pressure tank and the mold being vacuumed; and air in the resin within the pressure tank being completely pumped out of the pressure tank;
opening the valve opened so that the pressure source pressurizes the pressure tank and push the resin inside the pressure tank to the fiber in the cavity of the mold through the piping, the valve, and the left connector;
closing the valve and after the mold reaching a predetermined pressure measured by the pressure gauge so as to stop the infilling of resin into the mold;
turning on the heater to heat the resin and fiber in the cavity of the mold for thermosetting process;
turning off the heater after a predetermined reaction condition reached;
turning on the cooler to cool the mold and
opening the seal portion to remove the work piece after cooling process.

6. The method of claim 5, wherein the fiber in the cavity of the mold contains a filler for reducing the weight thereof.

7. The method of claim 5, wherein the fiber is one of a carbon fiber and a glass fiber.

8. The system of claim 1, wherein the composite material is suitable as material for car body and for electronic products.
